(19) United States
(12) Patent Application Publication
(10) Pub. No.: US 2003/0205066 A1
(43) Pub. Date: Nov. 6, 2003

(54) Method and apparatus for efficient cooling of optical fiber during its manufacture

(76) Inventors: M. Usman Ghani, Bolingbrook, IL (US); Ovidiu Marin, Lisle, IL (US); Philippe Queille, Paris (FR)

Correspondence Address: LINDA K. RUSSELL, AIR LIQUIDE, Suite 1800, 2700 Post Oak Blvd., Houston, TX, 77056, US

(21) Appl. No.: 10/352,105

(22) Filed: Jan. 28, 2003

Related U.S. Application Data
(60) Provisional application No. 60/367,255, filed on Mar. 25, 2002.

(51) Int. Cl. C03B 37/10

(52) U.S. Cl. 65/430; 65/434; 65/513

(57) ABSTRACT

A method and apparatus are described for efficient and economical cooling of drawn optical fibers prior to coating with resins. Optimum cooling is achieved employing a tubular cooling device with multiple cooling stages using gaseous coolants. A first stage uses a gas essentially free of helium while a second stage uses a helium-containing gas. The cooling apparatus includes a tubular device having a longitudinal axis, an inlet and outlet for passage of a drawn optical fiber, a wall extending transverse to the longitudinal axis of the cooling device dividing the space between the inlet and outlet into at least two cooling compartments, where the wall has an aperture to allow for passage of the fiber, means for passing gaseous coolant into the compartments, a jacket surrounding the compartments defining a space to circulate a cooling fluid, and porous means for minimizing flow-induced vibration of the fiber.

### CROSS-REFERENCE TO RELATED APPLICATIONS

This application claims the benefit of provisional application Serial No. 60/367,255, filed Mar. 25, 2002, the contents of which are hereby incorporated by reference in their entirety.

### BACKGROUND OF THE INVENTION

1. Field of the Invention

The present invention relates to a method and apparatus for cooling a drawn optical fiber. More particularly, the invention relates to a method and apparatus which employs multiple cooling zones to effectively and efficiently cool a drawn optical fiber.

2. Description of Related Art

The use of optical fibers to transmit information has become widespread. Advances in technology within the past two decades has necessitated transferring larger volumes of information which, in turn, has resulted in a greater demand for optical fibers. Currently, the industry is focusing on various means for increasing the production of optical fibers including increasing the draw speed. Draw speeds in the manufacture of optical fibers have increased significantly in the past few years. Current manufacturing processes use draw speeds of 1500 m/min. or higher.

A widely used process for manufacturing optical fibers is shown in FIG. 1. A glass preform is heated in a furnace to its softening temperature (around 2200° C.) and a fiber is drawn from the bottom portion of the molten preform. The fiber must conform to strict standards for diameter and strength. Therefore, a device is used to measure the diameter of the drawn fiber and thereby control the outer diameter of the uncoated fiber. The uncoated fiber is then cooled in a cooling unit, where its temperature is brought down to about 50° C. Following cooling, the fiber is coated with a UV-curable resin to protect it from abrasion, etc. The coated fiber is cured in a curing unit, processed through a capstan or guide roll, which provides the necessary tension for drawing, and finally wound on a spool.

Cooling optical fibers is an important step in manufacturing. The fiber temperature before coating must be low enough to provide a uniform coating of desired thickness. If the temperature of the fiber entering the coating process is too high, the thickness of the protective coating will be lower and may lead to inferior properties. With the ever-increasing demand to draw fibers at higher speeds, the cooling step plays a critical role in the overall process.

In current manufacturing processes, cooling of the fiber is generally achieved in two steps. During the first step, the fiber is cooled directly in air, primarily through radiative heat transfer. This cools the fiber significantly. The fiber is then passed through a cooler, shown schematically in FIG. 2, where it comes into contact with a coolant. A majority of the current processes use a gaseous stream composed primarily of helium, although other inert gases such as nitrogen, carbon dioxide, and argon have also been proposed.

Liquid and solid coolants have been proposed, but these may cause problems such as leakage. Also, there are concerns that if the hot fiber comes into contact with a very cold material, it may lead to structural or strength defects. In addition, the liquid or the solid must be totally removed before the coating can be applied.

Among the gaseous coolants, helium is generally preferred because of its excellent heat transfer properties. However, helium is obtained from nonrenewable sources and is expensive to produce. In prior processes, helium was either vented to the atmosphere or recovered, purified and recycled. For processes involving recovery, purification and recycling of helium, additional expensive equipment is needed.

There have been proposals (U.S. Pat. No. 6,279,354) to use thermoelectric coolers along with coolant gases such as helium and argon. However, the use of such devices is limited to low draw speeds on the order of 5 m/s. Other proposals (U.S. Pat. Nos. 4,966,615 and 4,761,168), have involved turbulent flow and means to break the boundary layer around the fiber such as by compartmentalization or mechanical intrusion. Nitrogen as a cryogenic gas has been suggested (U.S. Pat. No. 4,664,689) but it also requires expensive additional equipment.

U.S. published patent application 2001/0006262 A1 proposes using two cooling units. In the configuration described in this publication, the fiber is cooled in a first unit at a rate faster than that achieved by simple air-cooling. In a second unit, the fiber is cooled at a rate slower than that achieved by simple air-cooling. The claimed advantage of this configuration is that it minimizes the Rayleigh back scattering and does not cause excessive attenuation of the optical signals in the fiber. The preferred cooling fluid disclosed is helium or a mixture of helium and nitrogen.

Hence, no method is currently available which efficiently and economically cools the optical fiber after it has been drawn. In addition, with the demand for increased drawing speeds, it would be advantageous to optimize the cooling process for specific operating conditions.

It is an object of the invention to eliminate the aforementioned shortcomings of known processes and to provide a method and apparatus for efficient and economical cooling of drawn optical fibers before applying resin coatings.

Another object of the invention is to reduce the amount of helium used to cool drawn optical fibers while still attaining high draw speeds.

These and other objects and advantages of the invention will become apparent to the skilled artisan upon a review of the following description, the appended claims, and the figures of the drawings.

### SUMMARY OF THE INVENTION

The method of the present invention employs an apparatus which includes a tubular cooling device having multiple sections with separate streams of cooling gas for each section. The gas streams in each section can flow in a co-flow, counter-flow and cross-flow pattern with respect to the movement of the optical fiber. The flow pattern in each section can be set independently. For example, in a three section cooling device the flow pattern in the top, middle and bottom sections may be counter-flow, cross flow and co-flow, respectively. There may be total, partial or no cooling of the wall of the cooling device.

The invention provides an efficient and economical method and related apparatus for cooling the optical fiber before it is coated in the manufacturing process. For illustration purposes only, a cooling device consisting of two sections is shown in FIGS. 3-6. In the top section, nitrogen or some other gas (pure or as a mixture) is used as a coolant preferably at room temperature and pressure. In the bottom section, preferably helium (pure or in a gas mixture), or any alternate gas/mixture of gases is used as a coolant stream but at much lower flow rates as compared to the known prior art processes, which use a single cooling section. Preferably, both sections of the cooling device are cooled by a fluid such as water at room temperature or by a cryogenic fluid such as liquid nitrogen. At higher temperatures, the heat loss from the fiber is mainly due to radiation. At lower temperatures, the heat loss from the fiber is mainly by conduction and convection. That is where the present invention takes advantage of the excellent heat transfer properties of helium or alternative gaseous coolants.

### BRIEF DESCRIPTION OF THE DRAWING FIGURES

FIG. 1 is a flow diagram of a general process for manufacturing optical fibers.

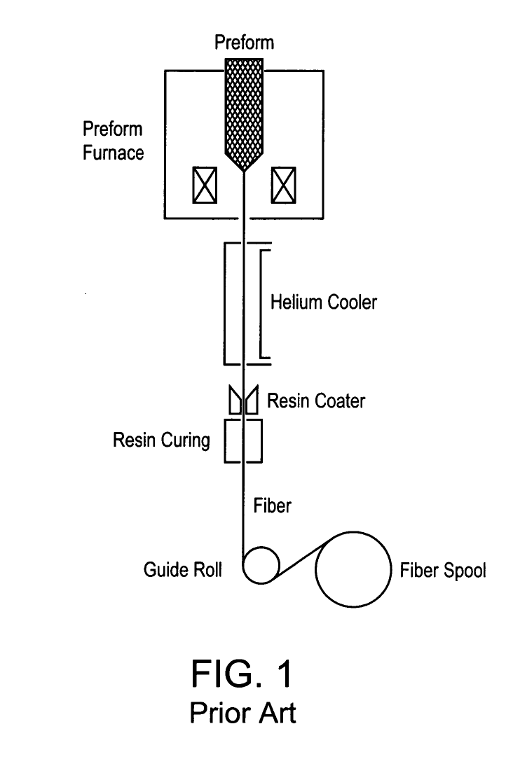

FIG. 2 is a diagrammatic view of a known cooling device.

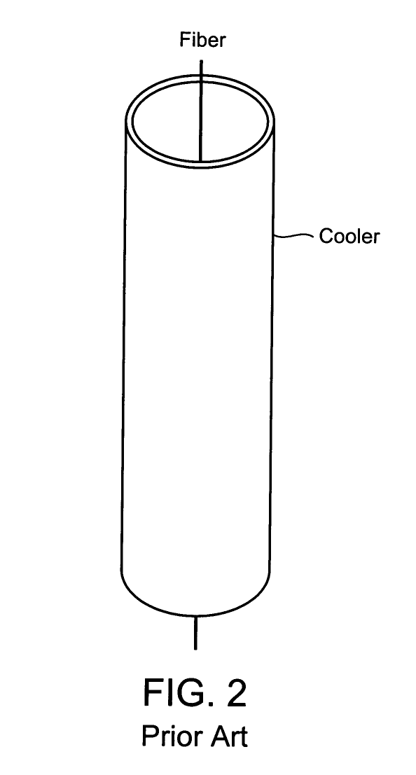

FIG. 3 is a diagrammatic view of a cooling device in accordance with the invention.

FIG. 4 is a diagrammatic view of a cooling device in accordance with a second embodiment of the invention.

FIG. 5 is a diagrammatic view of a cooling device in accordance with a third embodiment of the invention.

FIG. 6 is a diagrammatic view of a cooling device in accordance with a fourth embodiment of the invention.

FIG. 7 is a graph showing the calculated results and experimental data for coolants argon, helium and their mixtures.

FIG. 8 is a graph showing heat transfer behavior of helium, nitrogen and their mixtures.

FIG. 9 is a graph showing the optical fiber temperature profiles.

FIG. 10 is a schematic view of a cooling apparatus in accordance with one embodiment of the present invention.

FIG. 11 is a schematic view of a cooling apparatus in accordance with another embodiment of the invention.

### DETAILED DESCRIPTION OF PREFERRED EMBODIMENTS

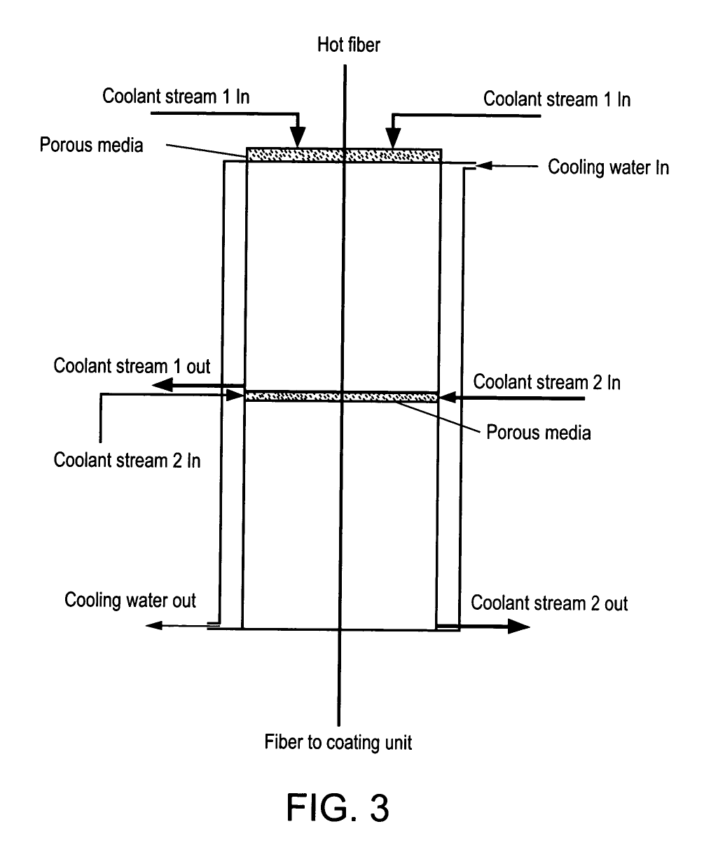

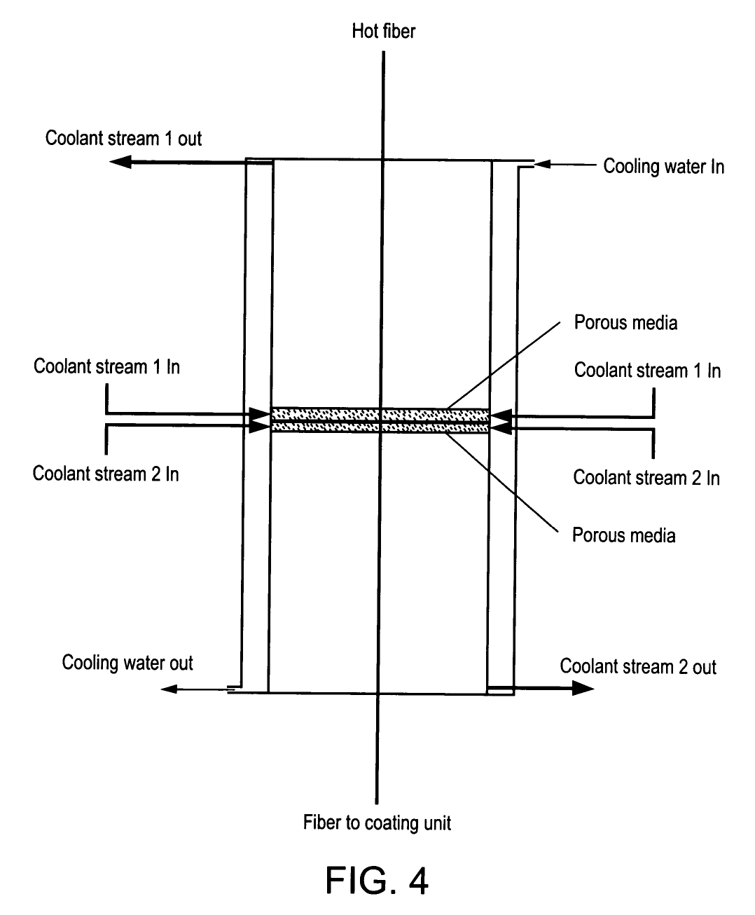

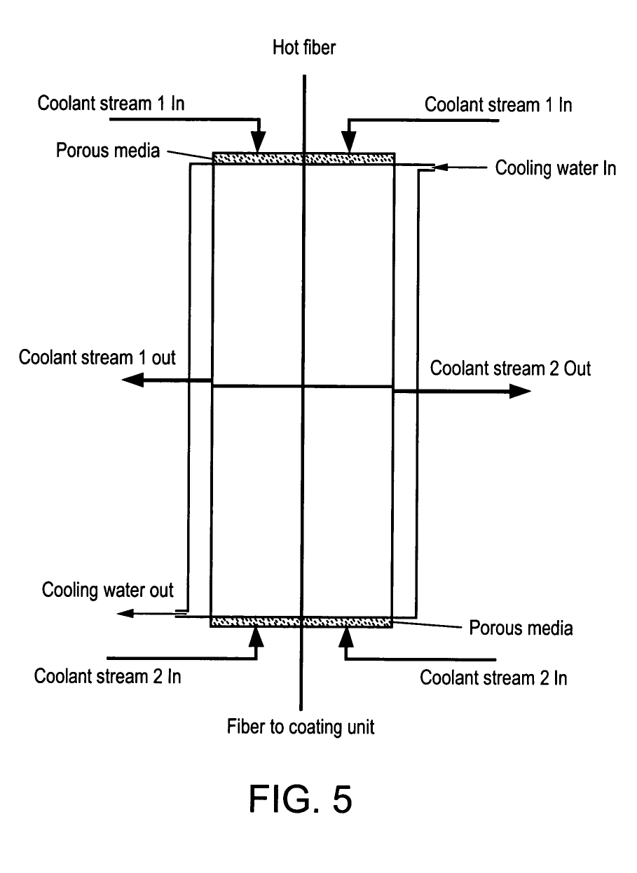

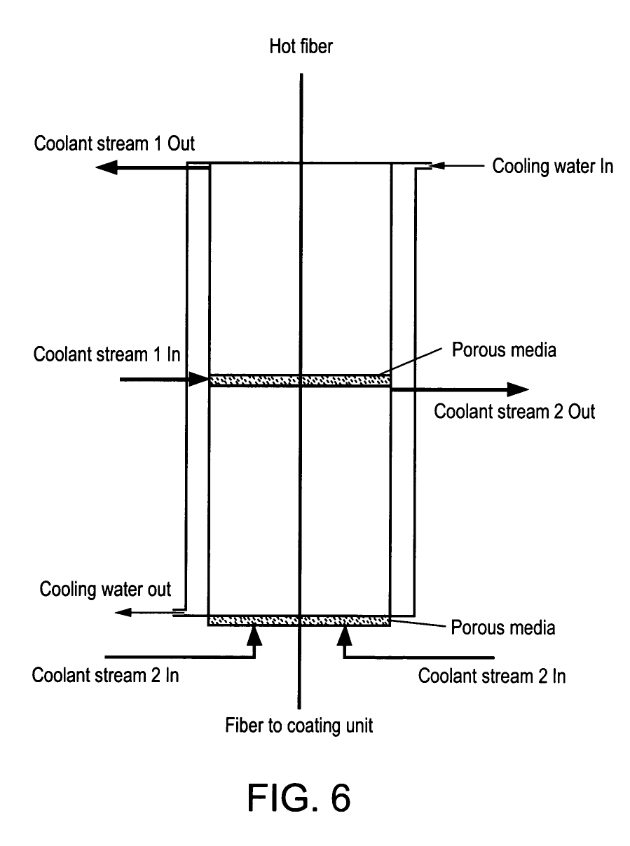

A simplified drawing of the invention, using two cooling sections, is shown in FIG. 3. The hot fiber comes in contact with the coolant stream in counter-flow, co-flow or cross-flow pattern. FIG. 3 shows a co-flow pattern. FIG. 4 shows a cooling device consisting of two sections with counter flow in the top section and co-flow in the bottom section. Similarly, FIG. 5 shows a cooling device consisting of two sections with co-flow in the top section and counter flow in the bottom section. Finally, FIG. 6 shows a cooling device consisting of two sections with counter flow in both sections. Likewise, for a multiple-section cooling device, the flow pattern in each section can be independently set.

An embodiment in which the coolant flows in the co-flow pattern in both sections as shown in FIG. 3. The coolant stream 1 passes through a porous disk at the top of the cooler and is introduced in the cylindrical passage of the cooler. The disk is intended to reduce the possibility of flow-induced vibration of the fiber. At a location downstream, the first coolant stream is withdrawn from the cooler. This stream can either be vented to the atmosphere or recycled in an exchanger, which is cooled by water or with a cryogenic liquid such as liquid nitrogen. In the embodiment of FIG. 3, cooling of this stream is not performed. A preferred embodiment of the invention involves cooling and recycling of this stream. Immediately downstream, a second coolant stream is injected into the cylindrical passage after passing through a porous disk. Appropriate seals are provided to minimize the contamination of the stream either by air or other gases. The location where the first stream is taken off and the second stream is injected can be optimized to meet specific process conditions. In addition, the number of cooling sections may also be optimized to achieve maximum cooling efficiency and least consumption of expensive helium gas. As fiber draw speeds increase in the optical fiber manufacturing units, multiple section cooling units with separate coolant streams are expected to provide an efficient and cost effective means of achieving desired level of cooling before a coating is applied to the fiber.

The choice of suitable gases for the cooling streams is an important consideration. The first coolant stream is composed of a gas which is essentially free of helium. By “essentially free”, we mean that any helium present should be minimal, i.e. less than about 1% by volume. Gases such as nitrogen, argon, and CO₂ may be used alone or in admixture. Preferably, pure nitrogen is used as the first coolant.

The second coolant stream preferably is composed of helium or mixtures thereof with argon or nitrogen. Pure nitrogen could be used if desired.

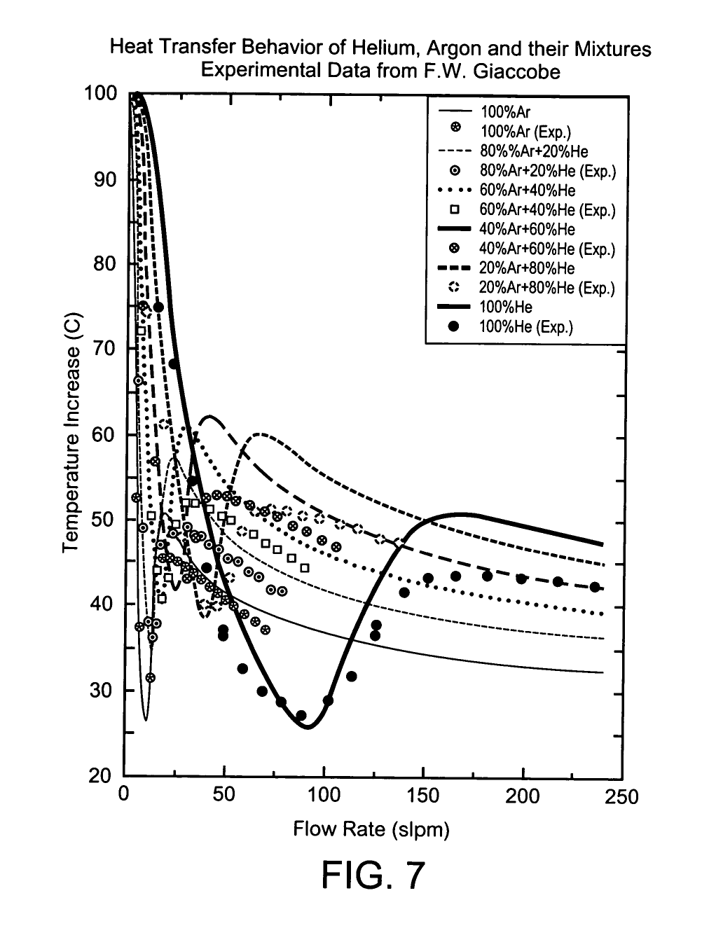

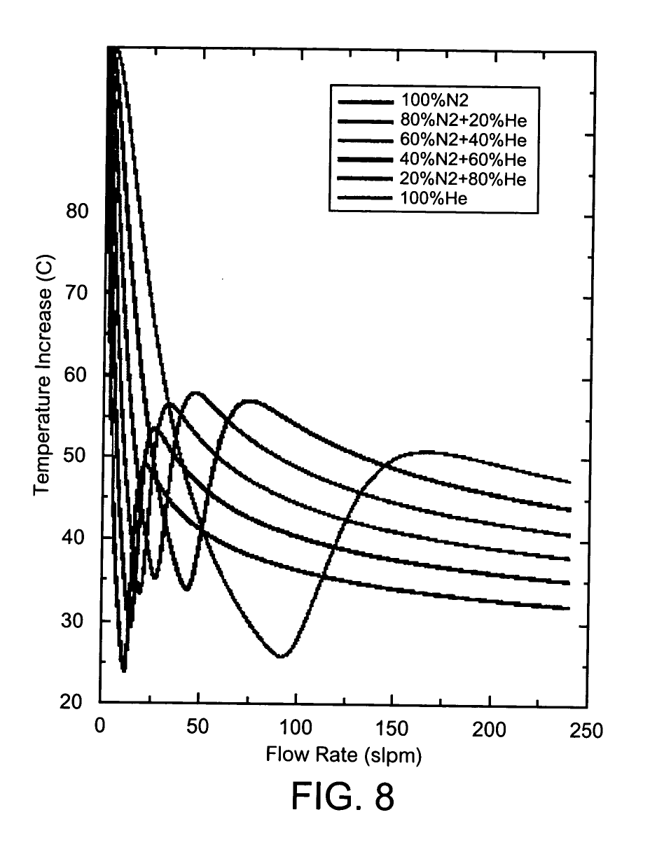

The effectiveness of a cooling stream very strongly depends upon the flow regime, such as laminar or turbulent, in the cooling device. At higher flow rates, binary mixtures of helium with another inert gas, such as argon, are more efficient than pure helium. FIG. 7 shows the calculated results as well as the experimental data obtained from a setup where the temperature increase in a gas stream flowing through a copper tube maintained at constant temperature was measured at various flow rates for argon, helium and their mixtures. The calculated results are in good agreement with the experimental data. FIG. 8 shows the calculated increase in temperature for the same setup using helium, nitrogen and their mixtures. The percent gases in the mixtures are on a volume basis. This data shows that the effectiveness of helium/nitrogen mixtures is comparable to helium/argon mixtures. These results indicate that at higher draw speeds for the optical fiber, the use of a binary gas mixture of helium/argon or helium/nitrogen could provide more efficient cooling of the optical fiber in comparison to pure helium or pure nitrogen streams.

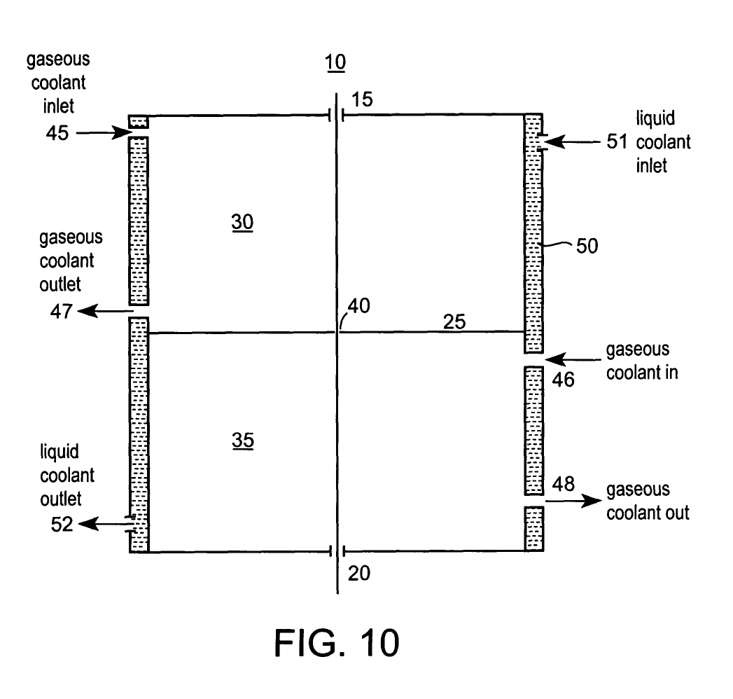

FIG. 10 shows a cooling apparatus which may be used to practice one embodiment of the method of the invention. The apparatus includes a tubular cooling device 10 having a longitudinal axis, an inlet port 15 and an outlet port 20 to provide passage for a drawn optical fiber, a wall 25 extending traverse to the longitudinal axis to divide the space between the inlet and outlet ports into two cooling compartments 30 and 35, the wall having an aperture 40 to allow for passage of the fiber. The cooling apparatus also includes inlet means 45 and 46 for passing gaseous coolant into compartments 30 and 35, respectively, outlet means 47 and 48 to remove gaseous coolant, a jacket 50 surrounding the compartments with inlet and outlet ports 51, 52 defining a space to circulate a cooling fluid. The cooling fluid circulated in jacket 50 can be water or a cryogenic liquid such as liquid nitrogen.

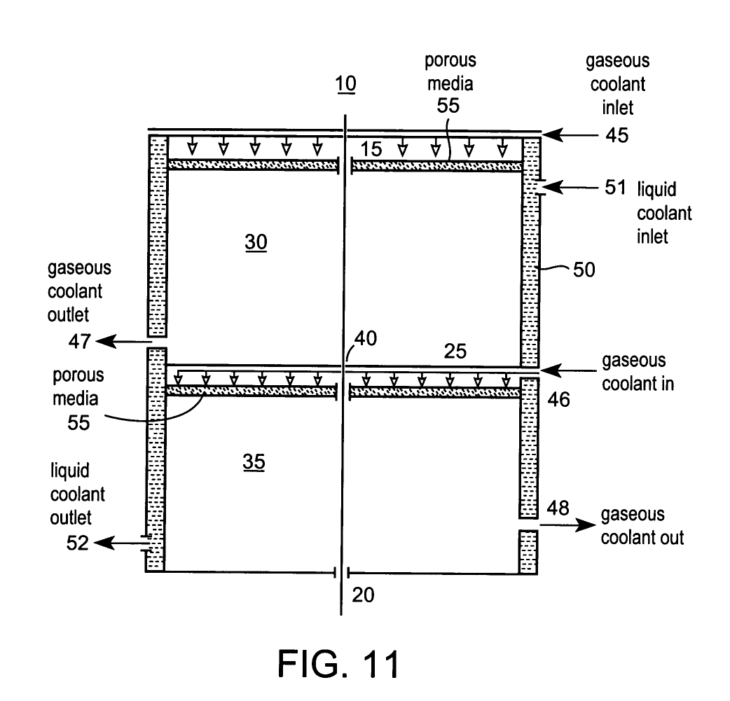

FIG. 11 shows a preferred cooling apparatus in accordance with a different embodiment of the invention. Gaseous coolant is distributed uniformly over porous media 55 before introduction into the compartments. Porous media 55, which may be disk-shaped, acts to minimize any flow-induced vibration of the fiber.

The cooling apparatus may include moving means to vary the distance between the furnace from which the fiber is drawn and the tubular device. The apparatus also includes means for withdrawing gaseous coolant from the cooling compartments, and means for recycling gaseous coolant back to the compartments. The apparatus would also include sources for the gaseous coolants.

A coating unit is provided below the cooling device. The cooled optical fiber is coated in known manner with a UV-curable resin such as an acryl or silicone resin to provide abrasion resistance and protection from damage. Suitable UV-curable resins are well-known in this art. A curing unit is provided after coating to cure the resin coating in known manner.

The invention will now be illustrated by the following example which is intended to be merely exemplary and in no manner limiting.

### EXAMPLE

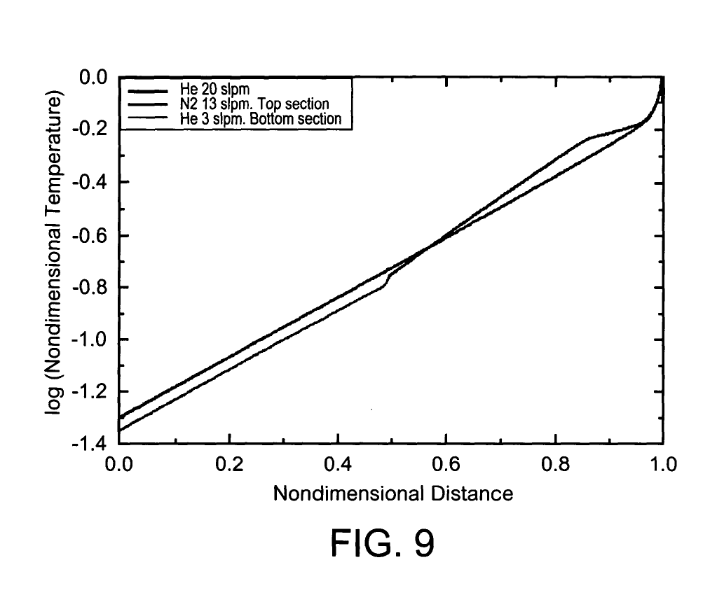

An optical fiber is introduced at the top of a cooling device at a temperature of 800° C. This temperature depends upon the position of the cooling device from the bottom of the draw furnace. The cooling device may be moved up or down to get a higher or lower temperature respectively. The fiber is drawn at a speed of 20 m/s. FIG. 9 shows the calculated temperature profiles where fiber is cooled in a single stage unit with pure helium and when fiber is cooled in two stages as in the present invention.

The results show that with a combination of two cooling sections using pure nitrogen and pure helium streams in the top and bottom sections respectively, more efficient cooling of the fiber is achieved compared to a single stage cooling device. Furthermore, the consumption of expensive helium has dropped from 20 slpm to 3 slpm without adversely affecting drawing speeds.

The number of cooling sections as well as the locations of the ports may be adjusted to achieve an optimal cooling profile for the specific conditions of operation. The cross-sectional profile of the cooling device may also be optimized to further improve the cooling efficiency.

It may be seen from the above, that the invention involves cooling with multiple sections where each section uses a separate coolant stream. An example of the device, consisting of two cooling sections, is presented in which two separate gas streams, namely nitrogen and helium, are used in the top and bottom sections respectively. The cooling achieved by the fiber, drawn at 20 m/s, is better than that achievable in a single stage device using pure helium. In addition, there is significant reduction in the use of the expensive helium gas. In the top section, gases other than nitrogen, but not pure helium, may also be used.

Although the above Example shows a draw speed of 20 m/s, it should be understood that draw speeds may be higher or lower than 20 m/s while still retaining the benefits of the invention. For example, the process of the invention may be run at draw speeds of 5 m/s, preferably 10 m/s, and most preferably, 15 m/s. Optimum draw speeds can readily be determined by a skilled technician.

While the invention has been described with preferred embodiments, it is to be understood that variations and modifications may be resorted to as will be apparent to those skilled in the art. Such variations and modifications are to be considered within the purview and the scope of the claims appended hereto.

What is claimed is:

1. A method of cooling an optical fiber drawn from a molten glass preform comprising:
contacting a heated optical glass fiber with a gaseous coolant essentially free of helium; and, subsequently,
contacting the heated optical glass fiber with a gaseous coolant containing helium.

2. The method according to claim 1, further including the step of applying a curable coating composition to the cooled fiber.

3. The method according to claim 1, wherein the gaseous coolant essentially free of helium comprises nitrogen, CO₂, argon or mixtures thereof.

4. The method according to claim 1, wherein the gaseous coolant containing helium is selected from the group consisting of a helium/nitrogen mixture, a helium/argon mixture and helium per se.

5. The method according to claim 1, wherein the optical fiber and at least one of the gaseous coolant are contacted in a counter-flow, cross-flow or co-flow direction with respect to the movement of fiber.

6. A method of cooling an optical fiber drawn from a molten glass preform comprising the steps of:
(a) passing a heated optical fiber to a cooling device having at least two cooling zones;
(b) contacting the heated fiber in a first cooling zone with a gaseous coolant substantially free of helium;
(c) passing the fiber to a second cooling zone;
(d) contacting the fiber in the second cooling zone with a gaseous coolant containing helium; and
(e) withdrawing the fiber from the cooling device.

7. The method according to claim 6, further comprising:
(f) applying a curable coating to the fiber withdrawn from the cooling device.

8. The method according to claim 7, wherein the curable coating is cured by UV radiation.

9. The method according to claim 6, wherein the gaseous coolant in step (b) comprises nitrogen, CO₂, argon or mixtures thereof.

10. The method according to claim 6, wherein the gaseous coolant in step (d) is selected from the group consisting of a helium/nitrogen mixture, a helium/argon mixture and helium per se.

11. The method according to claim 6, wherein the optical fiber and gaseous coolant in steps (b) and (d) are contacted in a counter-flow, cross-flow or co-flow direction with respect to the movement of the fiber.

12. The method according to claim 6, wherein the gaseous coolant is passed through a porous disk before contacting the fiber.

13. The method according to claim 6, wherein at least one additional cooling step is provided.

14. The method according to claim 6, wherein the gaseous coolants used in steps (b) and (d) are withdrawn, cooled and recycled back to the cooling zones.

15. The method according to claim 6, wherein the draw speed of the optical fiber is at least 5 m/s.

16. An apparatus for cooling an optical fiber comprising:
a tubular device defining a cooling area through which the fiber to be cooled is passed, the device having a longitudinal axis, an inlet at one end and an outlet at the opposite end to allow for passage of the fiber;
at least one wall extending transverse to the longitudinal axis of the cooling device thereby dividing the space between the inlet and outlet into at least two cooling compartments, the wall having one aperture to allow for passage of the fiber;
means for passing gaseous coolant into the compartments;
jacket means surrounding at least one of the compartments defining a space to circulate a cooling fluid; and
porous means for minimizing flow-induced vibration of the fiber.

17. The apparatus according to claim 16, further including means for enabling the tubular device to be moved closer or further away from a furnace from which the fiber is drawn.

18. The apparatus according to claim 16, further including means for withdrawing a gaseous coolant from the cooling compartments and means for recycling the coolant back to the compartments.

19. The apparatus according to claim 16, further including means for providing gases for circulating to the compartments.

20. The apparatus according to claim 16, further including means for providing a coating to the cooled fiber after it exits the tubular device.
